(19) United States
(12) Patent Application Publication
(10) Pub. No.: US 2009/0061271 A1
(43) Pub. Date: Mar. 5, 2009

(54) Fuel cell and a fuel cell system

(75) Inventors: Shouji Sekino, Tokyo (JP); Kenji Kobayashi, Tokyo (JP); Hideaki Sasaki, Tokyo (JP); Takeshi Obata, Tokyo (JP); Shin Nakamura, Tokyo (JP); Tsutomu Yoshitake, Tokyo (JP); Yoshimi Kubo, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 11/920,096

(22) PCT Filed: May 1, 2006
(86) PCT No.: PCT/JP2006/309084

§ 371 Date: Nov. 8, 2007

(30) Foreign Application Priority Data
May 11, 2005 (JP) 2005-138909

(51) Int. Cl. H01M 8/04; H01M 8/10

(52) U.S. Cl. 429/26; 429/30

(57) ABSTRACT

For the purpose of efficiently discharging CO₂ generated therein while increasing the fuel utilization efficiency, a fuel cell comprises a solid polymer electrolyte membrane, a cathode arranged in contact with one side of the solid polymer electrolyte membrane, an anode arranged in contact with the other side of the solid polymer electrolyte membrane, a cathode collector and an anode collector respectively arranged in contact with the cathode and anode, a sealing member arranged in the rim of the solid polymer electrolyte membrane and sandwiched between the solid polymer electrolyte membrane and the anode collector, a fuel supply controlling membrane for vaporizing a liquid fuel and supplying the vaporized fuel to the anode, and a discharging unit for discharging a product produced by electrical reaction at the anode to the outside. An air vent formed in the sealing member serves as the discharging unit.

### TECHNICAL FIELD

The present invention relates to a fuel cell and a fuel cell system, and more particularly, to a fuel cell and a fuel cell system in which have a configuration able to exhaust a generated CO₂ efficiently with improving a fuel utilization efficiency.

### BACKGROUND ART

A solid-oxide fuel cell using a liquid fuel is actively researched and developed for power sources for various types of electronics devices particularly in portable devices today, since being easy to be miniaturized and lightweight.

The solid-oxide fuel cell includes a Membrane and Electrode Assembly (hereinafter to be referred to as MEA). In the MEA, a solid polymer electrolyte membrane is sandwiched between an anode and a cathode. A type of a fuel cell in which a liquid fuel is directly supplied to the anode is called a direct type fuel cell. In the direct type fuel cell, an electric power is generated through a mechanism described below. A supplied liquid fuel is decomposed by a catalysts supported by the anode to produce cations, anions, and an intermediate product. The produced cations move to the cathode side through the solid polymer electrolyte membrane. The produced electrons move to the cathode side via an outer load. The cations and the electrons react with oxygen in the air in the cathode to generate electric power. At this moment, carbon dioxide (CO₂) is generated as a reaction product. For example, in a direct methanol type fuel cell (DMFC) in which a methanol aqueous solution was directly used as the liquid fuel, a reaction shown in the following formula 1 is occurred in the anode, and a reaction shown in the following formula 2 is occurred in the cathode.

CH₃OH+H₂O→CO₂+6H⁺+6e⁻ (1)

6H⁺+6e⁻⁺3/2O₂→3H₂O (2)

In the DMFC, methanol as the fuel and a water may crossover to the cathode side through the solid polymer electrolyte membrane, since the liquid fuel is directly supplied to the anode. As a result, an electric potential decreases on generation of electric power, and the fuel itself vaporizes through the solid polymer electrolyte membrane to outside, thereby a fuel utilization efficiency cannot surpass a certain level. In Japanese Laid Open Patent Application (JP-P2000-353533A; related art 1) and Japanese Laid Open Patent Application (JP-P2001-15130A; related art 2), reducing the fuel vaporizing through the MEA is described. In these documents, the liquid fuel is supplied to the anode after being evaporated by a fuel supplying layer such as PTFE (poly-tetrafluoroethylene).

However, in case that the liquid fuel is supplied after being evaporated by the PTFE, CO₂ generated in the anode may be accumulated between the anode and the PTFE, since the liquid fuel is supplied by a pressure from a fuel supplying side or a capillary tube phenomenon and so on. When CO₂ is accumulated between the anode and the PTFE, a pressure on the fuel supplying side increases and the fuel is insufficiently supplied to the anode side. As a result, a stable electric power generation may be failed to be performed. Further, when a current at the electric power generation is higher, a generation of CO₂ increases. Therefore, a stable electric power generation cannot be maintained for a long time, and in addition, the MEA may be easily destructed.

On the other hand, a solution of CO₂ exhaust is described in Japanese Laid Open Patent Application (JP-P2001-102070A: related art 3). In this document, an outlet for discharging CO₂ is provided for a liquid fuel introducing tube part or a side of a fuel retaining part, via a vapor-liquid separation membrane. However, if the outlet for discharging CO₂ exists on such a position, CO₂ generated in the anode easily flows into an inverse direction toward the liquid fuel introducing tube to be accumulated between the liquid fuel retaining part and the anode. As a result, a fuel supply to the anode is prevented, and a stable driving for a long time is hard to be realized.

Similarly, in Japanese Laid Open Patent Application (JP-P2003-317745A: related art 4), it is described to provide an outlet for discharging CO₂ under a wicking material. However, when the outlet is provided under the wicking material, CO₂ is required to pass through the wicking material in a reverse direction in order to be eliminated. For this reason, the fuel supply to the anode is prevented, and the stable driving for a long time is hard to be realized

In Japanese Laid Open Patent Application (JP-P2003-346862A: related art 5), a liquid supplying type fuel cell is described which has a structure for discharging CO₂ from an anode neighborhood to an outside via a vapor-liquid separation membrane (PTFE). However, in this fuel cell, a structure is complicated because a valve is used as a discharging mechanism. Furthermore, a fuel supply to the MEA is prevented because the generated CO₂ easily flows into an inverse direction toward a fuel tank. As a result, it is hard to exhaust a gas from the valve stably.

In Japanese Laid Open Patent Application (JP-P2002-280016A: related art 6), a fuel cell having a structure in which a groove is formed in a power collector to exhaust CO₂ is described. However, as far as the liquid fuel is supplied, the liquid fuel leaks from the groove with CO₂. Thus its practical application is difficult.

### DISCLOSURE OF INVENTION

An exemplary object of the present invention is to provide a fuel cell and fuel cell system which is able to improve a fuel utilization efficiency and to exhaust generated CO₂ efficiently.

In an exemplary aspect of the present invention, a fuel cell includes: a solid polymer electrolyte membrane; a cathode configured to be arranged in contact with one side of the solid polymer electrolyte membrane; an anode configured to be arranged in contact with the another side of the solid polymer electrolyte membrane; a cathode power collector and an anode power collector configured to be arranged in contact with the cathode and the anode respectively; a sealing member configured to be arranged on a rim of the solid polymer electrolyte membrane to be sandwiched and held by the solid polymer electrolyte membrane and the anode power collector; a fuel supply controlling membrane configured to vaporize a liquid fuel to supply to the anode; and an discharging unit configured to discharge products generated by electric reactions in the anode to an outside. The discharging unit is an air vent formed in the sealing member.

The fuel cell described above includes the discharging unit for discharging products (mainly CO₂) produced by electric reactions in the anode. The discharging unit has the air vents formed in the sealing member held by the solid polymer electrolyte membrane and the anode power collector. Thus, CO₂ is able to be exhausted from the anode neighborhood while a vaporized fuel is supplied. As a result, CO₂ produced in the anode is not accumulated between the anode and the fuel supply controlling membrane. Increasing of a pressure at a fuel supply side can be prevented, and the fuel can be supplied sufficiently to the anode side. That is to say, according to the fuel cell of the present invention, the fuel utilization efficiency can be improved, and a stable electric generation can be maintained for a long time in a high electric current and voltage.

In another exemplary aspect of the present invention, the air vent is a concave part in concavities and convexities formed in the sealing member.

In further another exemplary aspect of the present invention, the sealing member includes a plurality of fractionated members, and the air vent is a clearance formed between the fractionated members of the sealing member.

In further another exemplary aspect of the present invention, a spacer is partly provided between the sealing member and the solid polymer electrolyte membrane, and the air vent is a clearance provided between the sealing member and the solid polymer electrolyte membrane by the spacer.

According to these inventions, a simple and low-cost structure is used, and CO₂ can be drafted from the anode neighborhood without providing a complicated mechanism for discharging CO₂.

In further another exemplary aspect of the present invention, the fuel cell includes: a solid polymer electrolyte membrane; a cathode arranged in contact with one side of the solid polymer electrolyte membrane; an anode arranged in contact with another side; a cathode power collector and an anode power collector arranged in contact with the cathode and the anode respectively; a sealing member configured to be arranged on the anode side in a rim of the solid polymer electrolyte membrane with providing a clearance with the anode to be held by the solid polymer electrolyte membrane and the anode power collector; a fuel supply controlling membrane for evaporating a liquid fuel and supplying the liquid fuel to the anode; and an discharging unit for discharging products produced by an electric reactions in the anode to outside. The discharging unit includes an air vent provided in the solid polymer electrolyte membrane, and the air vent is provided at a position that is communicated to a clearance arranged between the anode and the sealing member.

The fuel cell of the above invention includes the discharging unit for discharging products (mainly CO₂) produced by the electric reactions in the anode, and the discharging unit has the air vent formed in a part which is not contacted with both of the sealing member and the anode, CO₂ is able to be drafted from the anode neighborhood while a vaporized fuel is supplied.

The fuel cell described above further includes: a sealing member arranged on the cathode side in a rim of the solid polymer electrolyte membrane with providing a clearance with the cathode. The sealing member is held by the solid polymer electrolyte membrane and the cathode power collector therebetween. The discharging unit includes a discharging hole provided in the sealing member.

According to these inventions, a simple and low-cost structure is used, and CO₂ can be drafted from the anode neighborhood without providing a complicated mechanism for discharging CO₂.

In a fuel cell system of the present invention, a plurality of the fuel cell described above is arranged along a uniaxial direction in a same plane. An oxidant supplied to the cathode flows in parallel with the uniaxial direction. The discharging unit is formed so as to discharge products to a direction that is nonparallel with the uniaxial direction.

In the plane stack structure, when an air stream mainly of the oxidant stream is supplied along an arrangement of the plurality of the fuel cells, it is preferable that the air stream is not prevented. According to the present invention, the air stream is not prevented because the discharging unit discharges products to the direction which is nonparallel with the uniaxial direction.

Accordingly, a sufficient air stream can be supplied to the each fuel cell. As a result, the power generation efficiency can be improved.

In the fuel cell system described above, it is preferable that the discharging unit is formed so as to discharge products to a direction which is perpendicular to the uniaxial direction in the plane of the plurality of the fuel cells.

According to the present invention, since CO₂ is able to be eliminated from the anode neighborhood while the vaporized fuel is supplied, CO₂ generated in the anode is not accumulated between the anode and the fuel supply controlling membrane. An increasing of pressure at the fuel supply side can be prevented, and the fuel can be sufficiently supplied to the anode side. As a result, the fuel utilization efficiency can be improved, and a stable electric power generation can be realized for a long time even in a high electric current and potential.

According to the fuel cell of the present invention, since an exhaust against a flow of the air stream is reduced and a sufficient air stream can be supplied to the respective fuel cells, the power generation efficiency is able to be improved.

### BRIEF DESCRIPTION OF DRAWINGS

FIG. 1 shows a diagram schematically showing a general sealing member;

FIG. 2 is a diagram showing a flowing direction of an air stream in a fuel cell system of a planar stack structure and showing a direction to which CO₂ is exhausted from the fuel cell;

FIG. 3A is a cross sectional view showing an example of a cell structure of the present invention;

FIG. 3B is a cross sectional view showing an example of another cell structure of the present invention;

FIG. 4 is a diagram schematically showing an example of a sealing member having air vents in the fuel cell of the present invention;

FIG. 5 is a diagram schematically showing another example of the sealing member having air vents in the fuel cell of the present invention;

FIG. 6 is a diagram schematically showing another example of the sealing member having air vents in the fuel cell of the present invention;

FIG. 7 is a cross sectional view schematically showing an example of a discharging unit according to a second embodiment of the present invention;

FIG. 8 is a diagram showing a flowing direction of the air stream in a fuel cell system of a planar stack structure and showing a direction to which CO₂ is exhausted from the fuel cell;

FIG. 9A is a diagram schematically showing an example of a fuel cell system of the present invention;

FIG. 9B is a diagram schematically showing an example of the fuel cell system of the present invention;

FIG. 9C is a diagram schematically showing an example of the fuel cell system of the present invention;

FIG. 9D is a diagram schematically showing an example of the fuel cell system of the present invention; and

FIG. 10 is a diagram showing a temporal potential change during an electric power generation when an initial value of the potential is normalized as 1, regarding the fuel cells of an experimental example 1 and a comparison example 1.

### BEST MODE FOR CARRYING OUT THE INVENTION

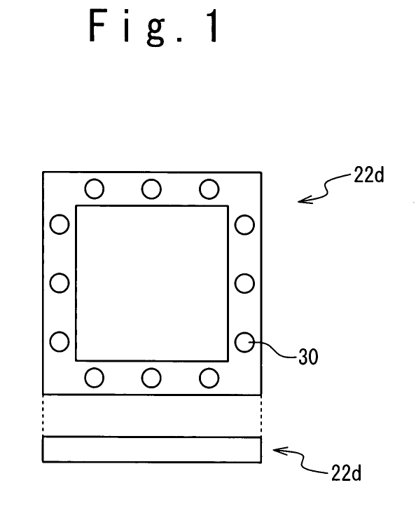

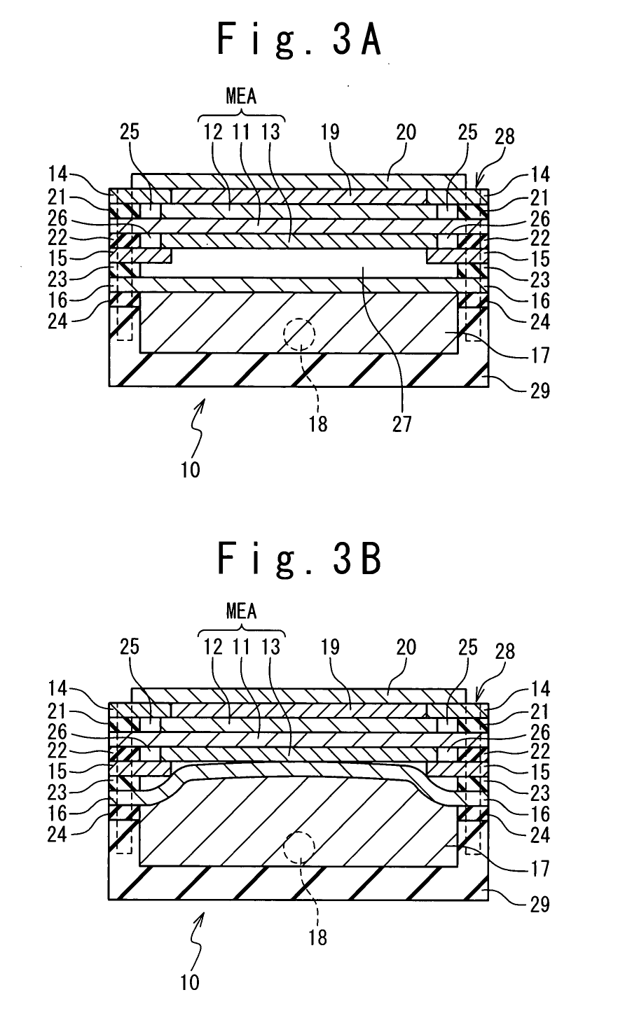

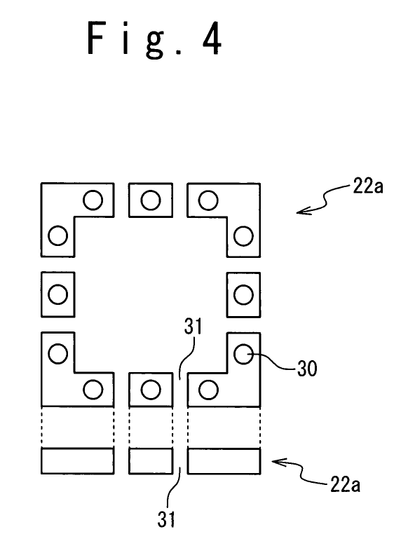

Referring to the attached drawings, a fuel cell and a fuel cell system according to the present invention will be explained below. FIG. 3A is a cross sectional view showing an example of a structure of the fuel cell of the present invention. FIGS. 4 to 6 are diagrams schematically showing examples of sealing members having air vents in the fuel cell of the present invention. FIG. 1 is a schematic diagram of a general sealing member. The present invention is not restricted to these drawings and embodiments explained below.

### (Fuel Cell)

As shown in FIG. 3A, a fuel cell 10 of the present invention includes a solid polymer electrolyte membrane 11, a cathode 12 arranged in contact with one surface of the solid polymer electrolyte membrane 11, an anode 13 arranged in contact with another surface thereof, a cathode power collector 14 and an anode power collector 15 respectively arranged in contact with the cathode 12 and the anode 13, a sealing member 22 arranged on a rim of the solid polymer electrolyte membrane 11 and sandwiched and held by the solid polymer electrolyte membrane 11 and the anode power collector 15, a fuel supply controlling membrane 16 for evaporating a liquid fuel to supply to the anode 13, and a discharging unit for discharging products produced through electric reactions in the anode 13. In addition, the solid polymer electrolyte membrane 11, the cathode 12, and the anode 13 configure a MEA (Membrane and Electrode Assembly). The cathode power collector 14 and the anode power collector 15 are bonded with pressure on upper and lower surfaces of the MEA through holding spacers 21 and 22, respectively.

In the fuel cell 10 exemplified in FIG. 3A, an evaporation suppressing member 19 and a cover member 20 are provided on the cathode 12 (an upper side in FIG. 3A) in this order. A fuel tank section 17 is provided on the fuel supply controlling membrane 16 (a lower side in FIG. 3A). A fuel input port 18 is provided in the fuel tank section 17.

A dashed line indicated by a numeral 28 shows a screw hole. A numeral 29 shows a cell frame. A numeral 23 shows a sealing member between the anode power collector 15 and the fuel supply controlling membrane 16. A numeral 24 shows a sealing member between the fuel supply controlling membrane 16 and the cell frame 29. A numeral 25 shows a clearance between the cathode 12 and the sealing member 21. A numeral 26 shows a clearance between the anode 13 and the sealing member 22. A numeral 27 shows a space formed between the anode 13 and the fuel supply controlling membrane 16. The space shown by the numeral 27 is not necessarily required to be provided, and the anode 13 and the fuel supply controlling membrane 16 may be tightly adhered to each other as shown in FIG. 3B. When the anode 13 and the fuel supply controlling membrane 16 are tightly adhered to each other, a power generation efficiency can be improved since the fuel transmitting the fuel supply controlling membrane 16 is directly supplied to the anode 13 without passing through a space. The fuel cell 10 of the present invention has a cell structure configured by these components and is secured to a cell body by a plurality of screws penetrating a rim of the cell structure.

The fuel cell 10 of the present invention is a direct methanol type fuel cell in which a methanol aqueous solution is directly used as a liquid fuel. Electric power generation occurs when the liquid fuel is evaporated by the fuel supply controlling membrane 16 to be supplied to the anode 13.

### (MEA)

The MEA (Membrane and Electrode Assembly) is configured to have a structure in which the solid polymer electrolyte membrane 11 is sandwiched and held by the cathode 12 and the anode 13. As the solid polymer electrolyte membrane 11, a polymer membrane is preferably used which has a corrosion resistance to the fuel, a high conductivity of hydrogen ions (protons), and no electron conductivity. As constituent materials of the solid polymer electrolyte membrane 11, an ionic exchange resin having a polar radical group is preferable which has a strong acid group or a weak acid group; as the strong acid group, a sulfone group, a phosphate group, a phosphonate group, and a phosphine group are exemplified; as the weak acid group, a carboxyl group is exemplified. As specific examples, a perfluorosulfonate resin, a sulfonated polyethersulfonate resin, and a sulfonated polyimide resin can be exemplified. More specifically, sulfonated poly(4-phenoxy benzoil-1,4-phenilene), sulfonated polyetheretherketone, sulfonated polyethersufon, sulfonated polysulfone, sulfonated polyimide, alkylsulfonated polybenzimidazole, and the like can be exemplified. A thickness of the solid polymer electrolyte membrane can be selected within a range from 10 to 300 μm arbitrarily depending on its material and usage of the fuel cell.

### (Cathode and Anode)

The cathode 12 is an electrode for reducing oxygen to thereby generate water as shown in the aforementioned formula 2. For example, the cathode 12 can be obtained by forming a catalyst layer on a substrate such as a carbon paper. The catalyst layer includes proton conductors and particles (including powders) that contain catalysts supported by supports such as carbon, or includes the proton conductors and the catalysts without the supports. As the catalysts, platinum, rhodium, palladium, iridium, osmium, ruthenium, rhenium, gold, silver, nickel, cobalt, lanthanum, strontium, yttrium and the like can be exemplified. The catalyst layer may be formed of a single type of catalysts or a combination of 2 or more types of the catalysts. As particles for supporting the catalysts, carbon materials can be exemplified; as the carbon materials, acethylene black, ketchen black, carbon nano tube, and carbon nano horn can be exemplified as examples. When the carbon materials have a particle form, a size of the particles for supporting the catalysts is arbitrarily selected within a range from 0.01 to 0.1 μm, preferably from 0.02 to 0.06 μm. In order to support the catalysts on the particles, for example, an impregnating method can be applied.

As the substrate on which the catalyst layer is formed, the solid polymer electrolyte membrane and a substrate formed of porous materials having conductivity can be used. As the porous materials, carbon paper, carbon compact, sintered carbon compact, sintered metal, and foam metal can be exemplified. When the carbon paper is used as the substrate, it is preferable that the cathode 12 is bonded to the solid polymer electrolyte membrane 11 by a method such as a hot press, after the catalyst layer is formed on the substrate. The cathode 12 is bonded to the solid polymer electrolyte membrane 11 so that the catalyst layer can contact the solid polymer electrolyte membrane 11. An amount of the catalysts for a unit area of the cathode 12 can be arbitrarily selected within a range from 4 mg/cm² to 20 mg/cm² in consideration for a kind and size of the catalyst.

The anode 13 is an electrode for generating hydrogen ions, CO₂, and electrons from methanol and water as shown in the aforementioned formula 1. The anode 13 is configured by a similar way to the cathode 12. A catalyst layer and substrate of the anode 13 may be same as those of the cathode 12, or the catalyst layer and substrate of the anode 13 may be different from those of the cathode 12. Similar to a case of the cathode 12, an amount of the catalyst for a unit area of the anode 13 also can be arbitrarily selected within a range from 4 mg/cm² to 20 mg/cm in consideration for a kind of and size of the catalyst.

### (Power Collector)

The cathode power collector 14 and the anode power collector 15 are arranged in contact with the cathode 12 and the anode 13 respectively, and act so as to improve efficiencies of picking out electrons and supplying the electrons. The power collectors 14 and 15 may be a flame shape contacting a periphery part of the MEA as shown in FIGS. 3A to 3B, or the power collectors 14 and 15 may be a tabular or meshed shape contacting an entire surface of the MEA. As materials of the power collectors 14 and 15, stainless steel, sintered metal, foam metal, and the like can be used, or a material in which a metal material with high conductivity is plated on these metal, and the like can be used.

### (Sealing Member)

A plurality of sealing members having a sealing function is provided in the fuel cell 10 of the present invention. For example, as shown in FIGS. 3A to 3B; (i) between the solid polymer electrolyte membrane 11 and the cathode power collector 14, a sealing member 21 is provided on a rim of the cell structure in a frame shape, the sealing member 21 has almost the same thickness as that of the cathode 12; (ii) between the solid polymer electrolyte membrane 11 and the anode power collector 15, a sealing member 22 having almost the same thickness as that of the anode 13 is provided on a rim of the cell structure in a frame shape; (iii) between the anode power collector 15 and the fuel supply controlling membrane 16, a sealing member 23 is provided on a rim of the cell structure in a frame shape; (iv) between the fuel supply controlling membrane 16 and the cell frame 29, a sealing member 24 is provided on a rim of the cell structure in a frame shape. It is preferable that these respective sealing members have characteristics of sealing, insulation, and elasticity as needed. Usually, they are formed by rubber materials having sealing function such as silicon rubber and plastic materials.

It is preferable that the sealing members 21, 23, and 24 other than the sealing member 22 have a sealing function so as not to leak a fuel or the like. The discharging unit is provided in the sealing member 22 in order to exhaust CO₂ produced in the anode 13 efficiently.

### (Discharging Unit)

That is to say, the fuel cell of the present invention is characterized in that the discharging unit for discharging a product (CO₂) produced by electrical reaction in the anode 13 is provided. As a result, since CO₂ is efficiently exhausted from the discharging unit, an inner pressure of the cell can be prevented from increasing, and a blocking of a fuel supply from the fuel supply controlling membrane 16 to the anode 13 can be prevented. As the discharging unit, a first embodiment and a second embodiment described below can be exemplified in the present invention.

The discharging unit according to the first embodiment is configured by air vents formed in the sealing member 22, as shown in FIG. 4 to FIG. 6.

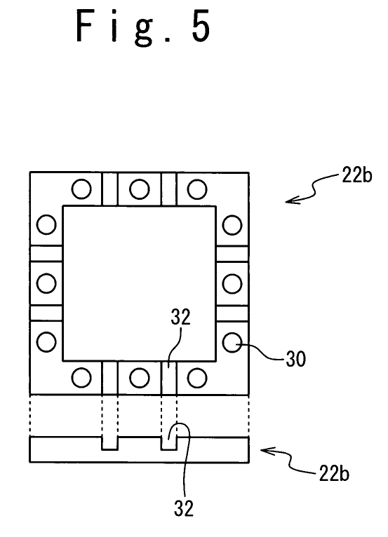

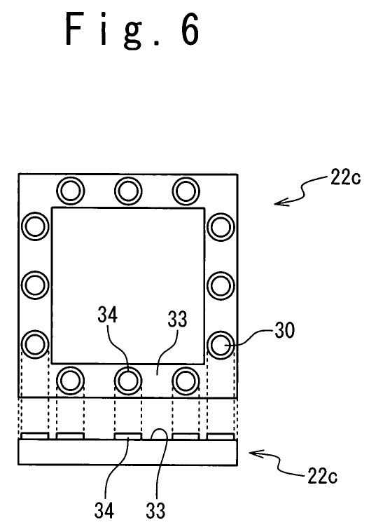

As examples of these air vents, following (i) to (iii) can be exemplified. (i) As shown in FIG. 4, the sealing member 22a is configured by a plurality of fractionated members, and clearances 31 formed between the fractionated members act as the air vents. (ii) As shown in FIG. 5, concave cuttings are formed in the sealing member 22b, and concave sections 32 of many concave sections and many convex sections act as the air vents. (iii) As shown in FIG. 6, cylindrical spacers 34 are provided on screw holes of the sealing member, and concave sections 33 between the spacers act as the air vents. On the other hand, FIG. 1 shows a conventional sealing member in which the air vents are not formed. In the sealing members shown in FIG. 4 to FIG. 6 and FIG. 1, screw holes 30 are formed, and the sealing member 22 is finally secured to the cell frame 29 by screws inserted in the screw holes 28 shown in FIGS. 3A to 3B. A securing is not restricted to a screwing, but the sealing member 22 can be secured by adhesive and the like.

The sealing member 22, the aforementioned cylindrical spacer 34, and the like can be made of plastic materials such as vinyl chloride, PET (Polyethylene terephthalate), PEEK (polyether etherkeyone), and rubber materials such as silicon rubber and butyl rubber.

The number and size of the air vents are not specifically restricted. However, it is preferable to assure the number and size so as to efficiently exhaust CO₂ at least. As shown in FIG. 4 to FIG. 6, the air vents may be provided on the four sides of a square frame. Also, the air vents may be provided on two facing sides. When the air vents are provided on the two facing sides, an exhaust against an air stream flowing in one way is reduced as will be explained below, and the air stream can be sufficiently supplied to the each fuel cell. As a result, the power generation efficiency can be improved. A specific size of the air vents is preferably determined with considering optimization. As an example, it is preferable that an area of the air vents occupy 2 to 50% against a section area of the anode in a thickness direction per one side.

CO₂ produced in the anode 13 during the electric power generation is supplied to the clearance 26 between the anode 13 and the sealing member 22 after being vented to a space between the anode 13 and the fuel supply controlling membrane 16. When the anode 13 and the fuel supply controlling membrane 16 adhere tightly each other, the CO₂ is directly supplied to the clearance 26 from a side of the anode 13, or the CO₂ is supplied to the clearance 26 via peripheral members (the anode power collector 15 and the fuel supply controlling membrane 16). After that, the CO₂ is exhausted from the air vents to an outside of the cell. Since the CO₂ can be drafted from the anode neighborhood while the evaporated fuel is supplied, the CO₂ is not accumulated between the anode 13 and the fuel supply controlling membrane 16. Increasing of a pressure on the fuel supply side can be prevented, and the fuel can be sufficiently supplied to the anode side. As a result, the fuel utilization efficiency can be improved, and a stable electric power generation at a high current can be realized for a long time. Furthermore, an electric power generation in a high potential can be realized.

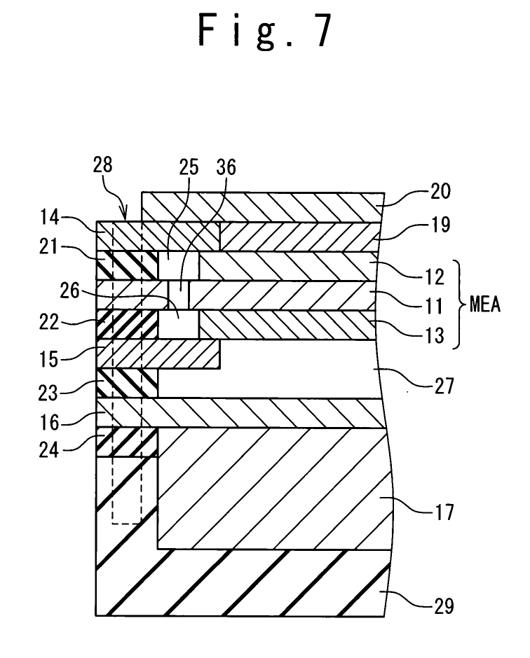

On the other hand, a discharging unit according to the second embodiment includes an air vent 36 formed in a part of the fuel supply controlling membrane 11 so as not to contact both of the sealing member 22 and the anode 13, as shown in FIG. 7. In the second embodiment, a product (CO₂) passing the air vent 36 is exhausted to the outside by passing through the cathode power collector 14, or the product is exhausted to the outside by passing through exhaust holes (not shown in the drawings) formed in the sealing member 21.

The air vent 36 is formed in the solid polymer electrolyte membrane 11 as shown in FIG. 7. The air vent 36 is provided in a part which does not contact both of the sealing member 22 and the anode 13. Similar to the first embodiment, a shape and size of the air vent 36 are not specifically restricted. However, it is preferable to assure at least a number and sizes so as to efficiently exhaust CO₂. Circular holes are provided in a rim of the solid polymer electrolyte membrane 11 with keeping a predetermined interval.

Also, in the discharging unit of this second embodiment, the CO₂ is supplied to the clearance 26 after being vented to a space between the anode 13 and the fuel supply controlling membrane 16. When the anode 13 and the fuel supply controlling membrane 16 adhere tightly each other, the CO₂ is supplied to the clearance 26 directly from a side of the anode 13, or the CO₂ is supplied to the clearance 26 via peripheral members (the anode power collector 15 and the fuel supply controlling membrane 16). After that, the CO₂ is supplied to the clearance 25 between the cathode 12 and the sealing member 21 passing through the air vent 36. After that, the CO₂ is exhausted from an exhaust hole (not shown in the drawing) formed in the sealing member 21. The CO₂ can be drafted from the anode neighborhood while the evaporated fuel is supplied. The CO₂ is not accumulated between the anode 13 and the fuel supply controlling membrane 16, and the increasing of pressure in the fuel supply side can be prevented. The fuel is sufficiently supplied to the anode side. As a result, the fuel utilization can be improved and a stable electric power generation at high current can be realized for a long time. Furthermore, the electric power generation with a higher potential can be realized.

### (Fuel Supply Controlling Membrane)

The fuel supply controlling membrane 16 is a control membrane for evaporating the fuel and controlling its supply. The fuel supply controlling membrane 16 acts so that a crossover for the anode 13 is suppressed. As a result, an optimum amount of the fuel can be supplied to the anode 13, and a stable electric power generation can be continued. The fuel is supplied to the fuel supply controlling membrane 16 from the fuel tank 17.

The fuel supply controlling membrane 16 is secured so as to contact the fuel tank 17. The fuel tank 17 has a fuel retaining material called a wicking material. A transmission speed of methanol transmitting the fuel supply controlling membrane 16 can be controlled by a pressure from the fuel retaining material and the like, and an optimum amount of methanol can be easily supplied. As the fuel supply controlling membrane 16, a vapor-liquid separation membrane such as a porous body of PTFE and the like is used. An amount of the fuel supplied to the fuel supply controlling membrane 16 is required to be more than a consumption amount of methanol in the MEA, the consumption amount is determined by a transmission rate of the liquid fuel, and the transmission rate depends on a membrane thickness and an air vent rate of the fuel supply controlling membrane 16.

### (Fuel Tank Section)

The fuel tank section 17 includes a fuel retaining material called a wicking material. The fuel input port 18 is provided in a part of the fuel tank section 17. The fuel retaining material can retain methanol aqueous solution (liquid fuel) by the capillary tube phenomenon. As the fuel retaining material, for example, fabric cloth, unwoven fabric, fiber mat, fiber web, and foam plastic can be used, in particular, the hydrophilic material such as hydrophilic urethane foam material and hydrophilic grass fiber are preferably used. When the fuel retaining material which is swollen by absorbing methanol aqueous solution is used, the methanol aqueous solution can be transferred to the fuel supply controlling membrane 16 side by a stress of swelling.

The fuel tank 17 having such fuel retaining material can supply the liquid fuel to the fuel supply controlling membrane 16 from the fuel retaining material without providing other method for transferring the liquid fuel. There will be no need to use a device such as a pump and a blower in order to transfer the liquid fuel. As a result, downsized solid polymer type fuel cell system can be configured. As shown in the drawings, it is preferable that the fuel supply controlling membrane 16 and the fuel tank section 17 contact each other so that the liquid fuel temporarily retained by the fuel retaining material can be directly supplied to the fuel supply controlling membrane 16.

### (Evaporation Suppressing Layer)

The evaporation suppressing member 19 is called a moisture retention layer, and act so as to suppress an evaporation of water produced in the cathode 12 during electric power generation. As the evaporation suppressing member 19, any material which can suppress the evaporation of water can be used, and both of a hydrophilic material and a hydrophobic material can be used; as the hydrophilic material, for example, fabric cloth, unwoven fabric, fiber mat, fiber web, and foam plastic are exemplified; as the hydrophobic material, a porous material such as the PTFE (polytetrafluoroethylene) which does not absorb water actively is exemplified. When this evaporation suppressing member 19 is used as a cover, by employing a structure for taking air from a side of the cover or employing a structure having holes in the cover itself, air required for the electric power generation can be supplied. By providing this evaporation suppressing member 19, methanol flowing to the cathode 12 during the crossover is oxidized, as a result, a decreasing of an electric potential can be suppressed. It is preferable that the evaporation suppressing member 19 and the cathode 12 contact each other, but the evaporation suppressing member 19 may be separated from the cathode 12 by using support members and spacers. The cover member 20 can be provided on the evaporation suppressing member 19 as needed.

As explained above, in the fuel cell 10 of the present invention, products (mainly CO₂) produced by electrochemical reaction autonomously pass the air vents formed in the sealing member 22 or the air vents formed in the solid polymer electrolyte membrane 11. Since the anode 13 is hard to be in positive pressure compared to the solid polymer electrolyte membrane 11 side, a stable supply of the evaporated fuel is possible even in a high current, a stable electronic power generation can be realized, and furthermore, an electronic power generation in a higher potential can be realized. The present invention has advantages in cost and safety, although a mechanism specialized for discharging CO₂ is not provided and its structure is quite simple, since the PTFE of the fuel supply controlling membrane prevents a leakage of the liquid fuel. Since a fuel evaporation via the MEA is reduced in a significant amount, the fuel is not consumed uneconomically, and the electric power generation can be carried out for a long time. It can be said that the structure of the present invention is completely different from those of aforementioned related art 5 and 6 in technical ideas. That is to say, in the fuel cells of related art 5 and 6, since a liquid fuel is supplied, a sealing performance of sealing members is improved in order to prevent a leakage of the liquid fuel. On the other hand, the fuel cell of the present invention does not require a strict sealing performance since the evaporated fuel is supplied, thus it can be realized to provide the air vents in the sealing member 22.

These air vents are effective especially in a planar stack structure in which a plurality of fuel cells is arranged in a plane. As a result of consideration by the inventors, it is clarified that the power generation efficiency greatly changes in the planar stack structure by devising an exhaust direction for an adjoining cell. Especially, when the air stream acting as oxidant is supplied in parallel with an arrangement of the plurality of cells, a supply of the oxidant may be gradually prevented because the exhaust is performed in the same or reverse direction of the air stream. In the air vents structure of the present invention, it is preferred to provide the air vents in a direction perpendicular to an direction in which the plurality of fuel cells are arranged.

### (Fuel Cell System)

Next, a fuel cell system will be explained. The fuel cell system of the present invention has a planar stack structure including a plurality of the fuel cells 10 according to the present invention described above. The plurality of fuel cells is arranged “at least” in a uniaxial direction on a plane. In the fuel cell system, an oxidant (air) supplied to the cathode 12 flows in parallel with the uniaxial direction. The discharging unit of the fuel cell 10 is provided so as to exhaust products in a direction which does not prevent an oxidant stream. The term “at least” is used to show that the present invention includes a case in which units are laminated, each of which has the plurality of the fuel cells 10 arranged in the uniaxial direction on the plane.

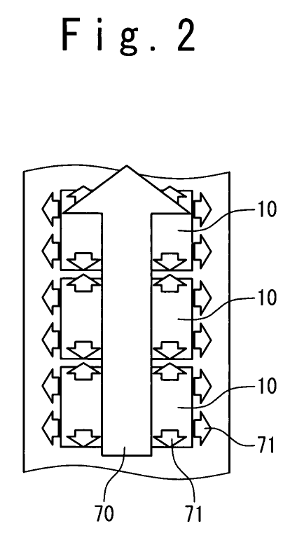

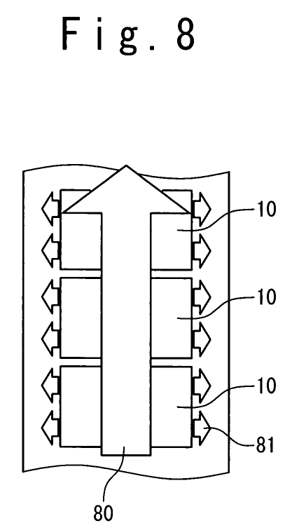

FIG. 2 is an explanation view showing a direction 70 of the air stream and an exhaust direction 71 of CO₂ exhausted from the fuel cell. FIG. 8 is another explanation view showing a direction 80 of the air stream and an exhaust direction 81 of CO₂ exhausted from the fuel cell.

In the fuel cell system shown in FIG. 2, CO₂ is exhausted from four directions of the fuel cell. Since a part of the exhaust flow overlaps the air stream, a part of exhaust flows against the air stream. As a result, a sufficient air stream may not be supplied to the respective fuel cells. On the other hand, in the fuel cell system shown in FIG. 8, CO₂ is not exhausted from four directions of the fuel cell but the CO₂ is exhausted from facing two sides in a vertical direction of the air stream. Since the exhaust flow does not overlap with the air stream so much, there is not much exhaust flow against the air stream. As a result, a sufficient air stream can be supplied to the respective fuel cells, and the power generation efficiency can be improved.

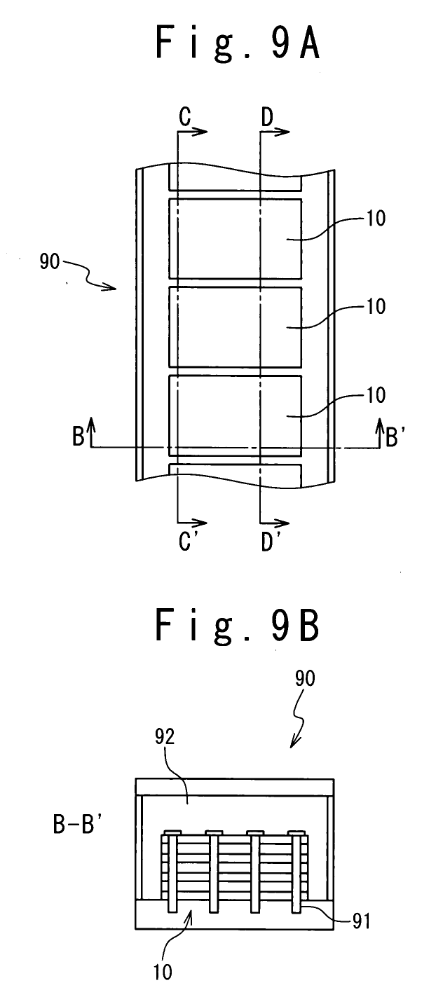

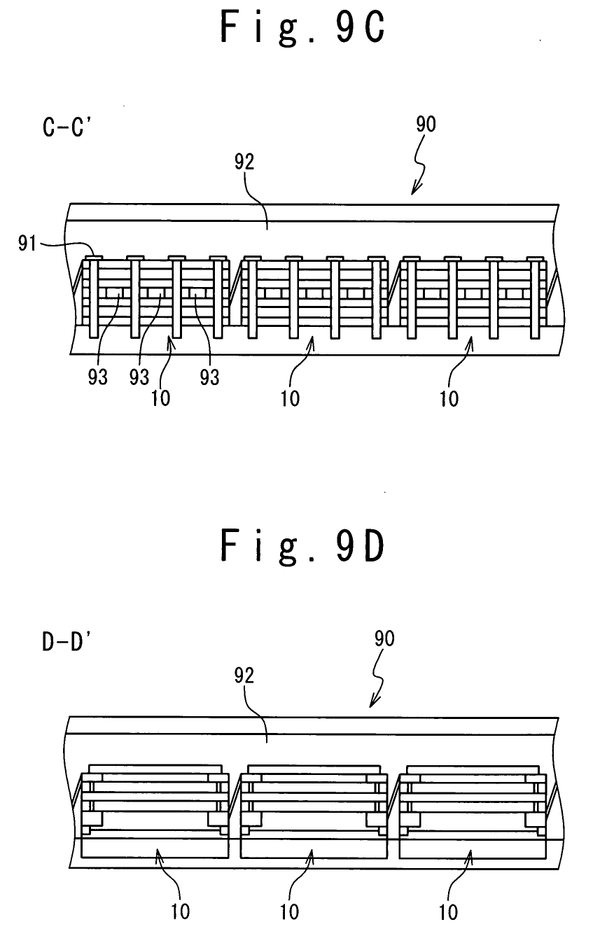

FIGS. 9A to 9D is a schematic view showing an example of the fuel cell system of the present invention. FIG. 9A is a planar view, FIG. 9B is a cross sectional view of B-B′, FIG. 9C is a cross sectional view of C-C′, and FIG. 9D is a cross sectional view of D-D′. As shown in FIGS. 9A to 9D, a fuel cell system 90 of the present invention has a planer stack structure including a plurality of the fuel cells 10 arranged in a uniaxial direction on a planer surface. In the planar stack structure, an oxidant (air) supplied to the cathode flows in parallel with the uniaxial direction. As shown in FIG. 9C, air vents 93 of the discharging units are formed so as to exhaust CO₂ to a direction which does not prevent the oxidant stream flowing in parallel with the uniaxial direction. A numeral 91 in FIGS. 9B and 9C shows a screw, a numeral 92 shows a flow path in which the air stream flows. In the cross sectional views of FIGS. 9B to D, hatchings to be given to a cross sectional view is abbreviated.

As described above, in the planar stack structure, when the air stream of the oxidant is supplied along an arrangement of the plurality of fuel cells, it is preferable not to prevent supply of the air stream. According to the fuel cell system of the present invention, since the discharging unit is formed so as to exhaust products to a direction which does not interrupt the oxidant stream, the exhaust against the air stream is reduced and a sufficient air stream can be supplied to the respective fuel cells. As a result, the power generation efficiency can be improved.

### Examples

The fuel cell of the present invention will be specifically explained by showing examples below.

### Example 1

A cell structure used in the example 1 will be explained below. At first, a catalyst supporting carbon microparticles was prepared; in the catalyst supporting carbon microparticles, platinum microparticles were supported by carbon particles (ketchen black EC600jD manufactured by LION Co., Ltd.) in 50% by weight ratio; a size of the platinum microparticles was within a range from 3 to 5 nm; Nafion solution of 5% by weight (manufactured by Dupon Co., Ltd.; name of commodity; DE521, “Nafion” is a registered trademark of Dupon Co., Ltd.) was added to the catalyst supporting carbon microparticles of 1 g; and a catalyst paste for forming a cathode was obtained by stirring. This catalyst paste was coated on a carbon paper (TGP-H-120 manufactured by To-re Co., Ltd.) as a base material by an applying amount of 8 mg/cm²; the catalyst paste was dried to manufacture a cathode sheet; a shape of the cathode sheet was 4 cm×4 cm. On the other hand, in stead of the platinum microparticles, by using alloy particles of platinum (Pt)-Ruthenium (Ru) (ratio of Ru is 50 at %) whose particle size is within a range from 3 to 5 nm, a catalyst paste for forming an anode was obtained. The catalyst paste for forming the anode was obtained in the same condition as that of the catalyst paste for forming the cathode except for using the alloy particles. The anode is manufactured in the same condition as a manufacturing condition of the cathode except for using the catalyst paste for forming the anode.

Next, a membrane of 8 cm ×8 cm×180 μm (thickness) composed of the Nafion 117 (number average molecular weight is 250000) manufactured by Dupon Co., Ltd was prepared as the solid polymer electrolyte membrane 11. The cathode was arranged on one surface of this membrane so that the carbon paper can face an outside; the anode was arranged on another surface so that the carbon paper can face the outside; a hot press was done from the outside of the respective carbon papers. Thereby, the cathode 12 and the anode 13 were bonded to the solid polymer electrolyte membrane 11, and the MEA (Membrane and Electrode Assembly) was obtained.

Next, the power collectors 14 and 15 were arranged on the cathode 12 and the anode 13; the each of the power collector 14 and 15 is a flame board in a rectangular shape; in each of the power collector 14 and 15, an area dimension was 6 cm², a thickness was 1 mm, and a width was 11 mm; and the flame board was made of stainless steel (SUS316) of thickness 200 μm. The sealing member 22 was arranged between the solid polymer electrolyte membrane 11 and the anode power collector 15; the sealing member was a flame board in a rectangular shape which was made of a silicon rubber; and in the sealing member 22, an area dimension was 6 cm², a thickness was 0.3 mm, and a width was 10 mm. Two notches of 0.5 mm width were provided in an each side of the sealing member 22 as the air vents for discharging CO₂. As the sealing member 21 between the solid polymer electrolyte membrane 11 and the cathode power collector 14 and the other sealing members 23 and 24 (see FIGS. 3A to 3B), flame boards made of silicon rubbers in a rectangular shape of 6 cm² in area dimension, 0.3 mm in thickness, and 10 mm in width were used.

Subsequently, as the fuel supply controlling membrane 16, a PTFE porous membrane (a pore size was 1.0 μm, a porosity was 80%) of 8 cm×8 cm×thickness 50 μm was prepared. A cotton fiber mat of 35 mm² was placed on the cathode 12 as the evaporation suppressing member 19 (moisture layer); the evaporation suppressing member 19 was secured by placing a punching sheet on the fiber mat as the cover member 20; a thickness of the punching sheet was 0.5 mm; a hole size of the punching sheet was 0.75 mm; a porosity of the punching sheet was 50%; and the punching sheet was made of PTFE. As the fuel tank, a case made of PP (polypropylene) was used; an outer dimension of the case was 6 cm²; a height of the case was 8 mm; an inner dimension area of the case was 44 mm²; a depth of the case was 3 mm; the fuel input port 18 for a fuel supply was provided on a side surface of the case; a wicking material was filled in the case as the fuel retaining material; and the wicking material was made of urethane material.

After that, the MEA, the cathode power collector, the anode power collector, the fuel supply controlling membrane, the sealing member, the evaporation suppressing layer, and the like were screwed to be combined by a predetermined number of screws, and the fuel cell according to the embodiment 1 was obtained.

### Comparison Example 1

A fuel cell of a comparison example 1 is manufactured in the same condition as that of the embodiment 1 except for using a sealing member without notching instead of the sealing member 22.

### (Experiment and Result)

About each of fuel cell of the example 1 and the comparison example 1, an electric power generation test was performed under a condition in which a current value was 2A; during the test, methanol aqueous solution 100 ml of 10 vol % was supplied in circles to the each fuel cell; a temperature of an air environment was 25° C.; and a humidity of the air environment was 50%. The electric power generation was performed for 10 minutes unless the electric power generation stopped halfway.

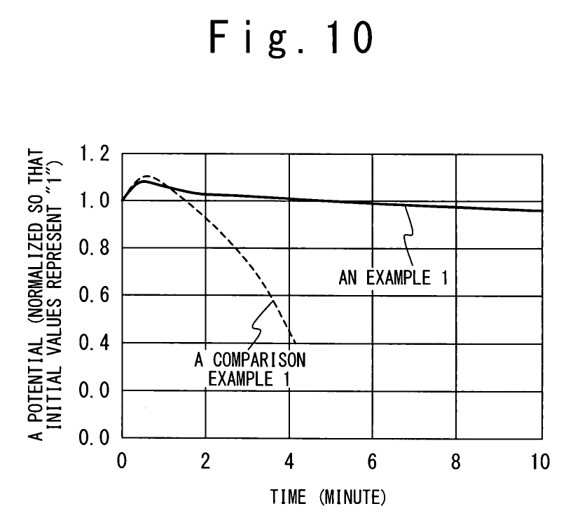

FIG. 10 is a graph showing a temporal change of a potential during the electric power generation regarding the example 1 and the comparison example 1. In FIG. 10, the graph was normalized so that an initial potential value of the each fuel cell represents “1”. In the fuel cell of the embodiment 1, since a clearance was provided in the sealing member 22 of the fuel cell, CO₂ produced in the anode can be eliminated from the clearance. As a result, CO₂ was not accumulated between the anode and the fuel supply controlling membrane, a result showing small reduction of electric potential can be obtained even at a high electric current of 2A, and a stable electric power generation was possible in a practical condition for a long time. This result showed that CO₂ was efficiently exhausted by providing the air vents in the sealing member, and it was confirmed that CO₂ was eliminated to outside efficiently. On the other hand, in the fuel cell of the comparison example 1, CO₂ produced in the anode was hard to be eliminated, an electric potential was reduced as time passed, and the electric power generation stopped in a few minutes.

Also, an experiment in which the electric power generation was continued for two hours in 1A was performed; the experiment was performed for each of the example 1 and the comparison example 1. A speed of a fuel consumption was 0.5 ml per hour in each case; it was confirmed that the speed of the fuel consumption was not reduced in spite of an existence and nonexistence of the air vents for CO₂. Since a general speed of the fuel consumption by supplying the liquid fuel not through fuel supply controlling membrane is about 1.5 ml per hour, effectiveness of a reduction of the fuel consumption was realized by the fuel supply controlling membrane, and a stable electric power generation was possible for a long time. As described above, it was confirmed that a low fuel consumption is kept, and a stable electric power generation is realized for a long time by the present invention.

1-8. (canceled)

9. A fuel cell comprising:
a solid polymer electrolyte membrane;
a cathode arranged in contact with one side of said solid polymer electrolyte membrane;
an anode arranged in contact with said other side of said solid polymer electrolyte membrane;
a cathode collector and an anode collector respectively arranged in contact with said cathode and anode;
a sealing member arranged in a rim of said solid polymer electrolyte membrane and sandwiched between said solid polymer electrolyte membrane and said anode collector;
a fuel supply controlling membrane configured to vaporize a liquid fuel to supply to said anode; and
a discharging unit configured to discharge a product produced by electric reaction at said anode,
wherein said discharging unit includes an air vent formed in said sealing member.

10. The fuel cell according to the claim 9, wherein said air vent is a concave portion formed on said sealing member.

11. The fuel cell according to the claim 9, wherein said sealing member includes a plurality of fractional members, and said air vent is a clearance formed between said plurality of fractional members.

12. The fuel cell according to the claim 9, wherein a spacer is provided in a part between said sealing member and said solid polymer electrolyte membrane, and said air vent is a clearance formed between said sealing member and said solid polymer electrolyte membrane by said spacer.

13. A fuel cell comprising:
a solid polymer electrolyte membrane;
a cathode arranged in contact with one side of said solid polymer electrolyte membrane;
an anode arranged in contact with said other side of said solid polymer electrolyte membrane;
a cathode collector and an anode collector respectively arranged in contact with said cathode and anode;
a sealing member arranged in a rim of said solid polymer electrolyte membrane and sandwiched between said solid polymer electrolyte membrane and said anode collector;
a fuel supply controlling membrane configured to vaporize a liquid fuel to supply to said anode; and
a discharging unit configured to discharge a product produced by electric reaction at said anode,
wherein said discharging unit includes an air vent formed in said solid polymer electrolyte membrane, and said air vent is configured to be communicated with a clearance between said anode and said sealing member.

14. The fuel cell according to the claim 13, further comprising:
a sealing member arranged on said cathode side in a rim of said solid polymer electrolyte membrane to keep a clearance with said cathode and sandwiched and held by said solid polymer electrolyte membrane and said cathode collector,
wherein said discharging unit includes discharging vents formed in said sealing member held by said solid polymer electrolyte membrane and said cathode.

15. A fuel cell system having a plurality of said fuel cells, each of which is defined according to the claim 9,
wherein said plurality of fuel cells are arranged in a uniaxial direction on a same plane, an oxidant supplied to said cathode flows in parallel with said uniaxial direction, and said discharging unit is configured to discharge said product to a direction nonparallel with said uniaxial direction.

16. The fuel cell system according to the claim 15, wherein said discharging unit is configured to discharge said product to a direction perpendicular to said uniaxial direction in the plane in which said plurality of fuel cells are arranged.

17. A fuel cell system having a plurality of said fuel cells, each of which is defined according to the claim 13,
wherein said plurality of fuel cells are arranged in a uniaxial direction on a same plane, an oxidant supplied to said cathode flows in parallel with said uniaxial direction, and said discharging unit is configured to discharge said product to a direction nonparallel with said uniaxial direction.

18. The fuel cell system according to the claim 17, wherein said discharging unit is configured to discharge said product to a direction perpendicular to said uniaxial direction in the plane in which said plurality of fuel cells are arranged.
